(19) United States
(12) Patent Application Publication
(10) Pub. No.: US 2015/0168333 A1
(43) Pub. Date: Jun. 18, 2015

(54) ELECTROCHEMICAL AFFINITY SENSING CHIPS INTEGRATED WITH FLUIDIC STIRRING AND OPERATION METHOD THEREOF

(71) Applicant: National Chung Hsing University, Taichung (TW)

(72) Inventor: Ching-Chou Wu, Taichung City (TW)

(21) Appl. No.: 14/296,399

(22) Filed: Jun. 4, 2014

(30) Foreign Application Priority Data
Dec. 13, 2013 (TW) 102146211

(51) Int. Cl. G01N 27/327

(52) U.S. Cl. CPC G01N 27/327

(57) ABSTRACT

An electrochemical affinity sensing chip integrated with fluidic stirring suitable for sensing objects is provided. The electrochemical affinity sensing chip integrated with fluidic stirring includes a substrate and a plurality of electrochemical-sensing electrode groups. The electrochemical-sensing electrode groups are disposed on the substrate and for electrochemically sensing the object. Each electrode group comprises a disk electrode, a first ring electrode, and a second ring electrode. The disk electrode is disk-shaped, and the electrode surface is immobilized with a probe. The first ring electrode is curved and surrounds the disk electrode. The second ring electrode is curved and surrounds the first ring electrode. The first ring electrode and the second ring electrode produce an alternating current electrohydrodynamic (ACEHD) stirring to promote the hybridization efficiency between the objects and the probes immobilized on the surface of disk electrode.

### CROSS-REFERENCE TO RELATED APPLICATION

This application claims the priority benefit of Taiwan application serial no. 102146211, filed on Dec. 13, 2013. The entirety of the above-mentioned patent application is hereby incorporated by reference herein and made a part of this specification.

### BACKGROUND OF THE INVENTION

1. Field of the Invention

The invention relates to a biosensing chip and an operation method thereof, and more particularly, to an electrochemical affinity sensing chip integrated with fluidic stirring suitable for sensing an object and an operation method thereof.

2. Description of Related Art

One of the common biosensing techniques is a affinity sensing chip, which performs measurement based on changes such as shape of bio molecules, charges, impedance, mass, heat, or steric hindrance of electrode surface when affinity binding such as receptor/ligand, antibody/antigen, or nucleic acid hybridization occurs. As compared to other sensing methods such as high performance liquid chromatography (HPLC) and enzyme-linked immunosorbent assay (ELISA) which are combined with UV or fluorescence method, an electrochemical affinity sensor may save a lot of cost and time on the sample pre-treatment procedures and equipment needs. However, the hybridization by the affinity reaction between the object and a probe modified on the electrode surface may be inefficient due to the Brownian motion of the object itself and a too slow diffusion based on concentration gradient. Moreover, if the size of the object is too small or the concentration of the object is too low, a binding amount between the object and the probe is limited, whereby the detection limit may not further be reduced.

In recent years, microfluidic techniques have been developed, wherein studies using electrokinetics-controlled techniques, such as alternating current-electroosmotic flow (ACEOF), dielectrophoresis (DEP), electrothermal flow (ETF), and induced-charge electroosmotic (ICEO), to control fluids, bio samples, or colloidal particles and other minor substances have drawn much attention. In electrohydrodynamics techniques, ACEOF is suitable for performing liquid stirring in a low conductivity solution and ACETF is suitable for performing liquid stirring in a high conductivity solution. Accordingly, it has been studied currently to integrate alternating current electrohydrodynamic control techniques of the electrokinetics with affinity sensing systems to reduce the detection limit. However, the costs of using the above-mentioned sensing methods are too high no matter on the pre-treatment procedures or the equipment needs due to the fact that the sensing method is through the optics or the need to use tagged probe or tagged object. Accordingly, a affinity sensing chip which successfully integrates the electrohydrodynamic stirring electrodes and the electrochemical sensing electrodes into the same electrode group and the same substrate is needed, so as to reduce the detection limit and to improve the detection rate simultaneously.

### SUMMARY OF THE INVENTION

The invention provides an electrochemical affinity sensing chip integrated with fluidic stirring, which may shorten the sensing time and reduce the detection limit.

The invention further provides an operation method of the electrochemical affinity sensing chip integrated with fluidic stirring, which is for operating the above-mentioned electrochemical affinity sensing chip integrated with fluidic stirring.

The electrochemical affinity sensing chip integrated with fluidic stirring of the invention, which is suitable for sensing an object, includes a substrate and a plurality of electrochemical-sensing electrode groups. The electrochemical-sensing electrode groups are disposed on the substrate and for electrochemically sensing the object, wherein each of the electrochemical-sensing electrode groups includes a disk electrode (DE), a first ring electrode (RE), and a second ring electrode. The disk electrode is disk-shaped and a surface thereof is immobilized with a probe. The first ring electrode is curved and surrounds the disk electrode. The second ring electrode is curved and surrounds the first ring electrode. The first ring electrode and the second ring electrode produce an alternating current electrohydrodynamic (ACEHD) stirring.

The operation method of an electrochemical affinity sensing chip integrated with fluidic stirring of the invention is suitable for sensing the object, and the operation method includes following steps. First, the electrochemical affinity sensing chip integrated with fluidic stirring which includes a plurality of electrochemical-sensing electrode groups is provided, wherein each of the electrochemical-sensing electrode groups comprises a disk electrode, a first ring electrode, and a second ring electrode. The disk electrode is disk-shaped and a surface thereof is immobilized with a probe. The first ring electrode is curved and surrounds the disk electrode. The second ring electrode is curved and surrounds the first ring electrode. Next, the object is loaded on the electrochemical affinity sensing chip integrated with fluidic stirring. Then, a voltage is applied to the first ring electrode and the second ring electrode to produce an alternating current electrohydrodynamic (ACEHD) stirring and to form a affinity binding between the object and the probe. Next, the object which is not binding to the probe is removed, and a solution is loaded on the electrochemical affinity sensing chip integrated with fluidic stirring. And then, an electrochemical sensing is performed by the disk electrode, the first ring electrode and the second ring electrode of the electrochemical affinity sensing chip integrated with fluidic stirring which binds with the object.

In an embodiment of the invention, the alternating current electrohydrodynamic stirring includes alternating current-electroosmotic flow (ACEOF), DC-biased alternating current-electroosmotic flow (DC-biased ACEOF), AC electrothermal flow, or AC electrokinetic flow, and the electrochemical sensing includes electrochemical impedance spectroscopy (EIS) or voltammetry.

In an embodiment of the invention, the object is moved from the second ring electrode to the first ring electrode by the alternating current electrohydrodynamic stirring, and the object is moved to the disk electrode which is immobilized with the probe according to inertia of fluid.

In an embodiment of the invention, in the electrochemical sensing, the disk electrode is as a working electrode, and one of the first ring electrode and the second ring electrode is as a counter electrode and another is as a reference electrode.

In an embodiment of the invention, the probe includes DNA, RNA, antibodies or aptamers, the object includes DNA, RNA, antigens, aptamers or drugs, and between the probe and the object is through the affinity binding.

In an embodiment of the invention, a first spacing is between the disk electrode and the first ring electrode, a second spacing is between the first ring electrode and the second ring electrode, and the first spacing and the second spacing are between 1 μm and 100 μm.

In an embodiment of the invention, a width of the first ring electrode is between 10 μm and 700 μm, a width of the second ring electrode is between 5 μm and 100 μm, and a diameter of the disk electrode is between 10 μm and 1000 μm.

In an embodiment of the invention, the width of the first ring electrode is larger than the width of the second ring electrode, and the width of the first ring electrode is 2 to 7 times larger than the width of the second ring electrode.

In an embodiment of the invention, materials of the disk electrode, the first ring electrode, and the second ring electrode include gold (Au), platinum (Pt), or palladium (Pd).

In an embodiment of the invention, the surface of the first ring electrode and the surface of the second ring electrode are covered with a protective layer to easily form a faradaic charging phenomenon at the first ring electrode and the second ring electrode, wherein materials of the protective layer and materials of the disk electrode are different.

In an embodiment of the invention, the protective layer includes a palladium layer, a platinum layer or an iridium oxide layer.

According to the above, the electrochemical-sensing electrode groups in the electrochemical affinity sensing chip integrated with fluidic stirring of the invention is designed as the double rings-single disk electrodes, which allows the working electrode, the counter electrode and the reference electrode to be integrated into the same chip. In other words, the ACEHD-driving electrode and the electrochemical sensing electrode are integrated into the same electrode group and the same chip in the sensing chip of the invention. Accordingly, the sensing time may be shortened and the detection limit may be reduced. In addition, the manufacturing costs of the electrodes may be reduced, which is further conductive to the miniaturization and the mass production of the biosensing chip.

In order to make the aforementioned and other features and advantages of the invention comprehensible, embodiments accompanied with figures are described in detail below.

### BRIEF DESCRIPTION OF THE DRAWINGS

FIG. 1 illustrates a schematic diagram of an electrochemical affinity sensing chip integrated with fluidic stirring according to an embodiment of the invention.

FIG. 2 illustrates a schematic diagram of a single electrochemical-sensing electrode group which is not immobilized with a probe of an electrochemical affinity sensing chip integrated with fluidic stirring according to an embodiment of the invention.

FIG. 3 illustrates a schematic diagram of a single electrochemical-sensing electrode group which is immobilized with a probe of an electrochemical affinity sensing chip integrated with fluidic stirring according to an embodiment of the invention.

FIG. 4 illustrates a block diagram of an operation method of an electrochemical affinity sensing chip integrated with fluidic stirring according to an embodiment of the invention.

FIG. 5A to FIG. 5G illustrate a schematic cross-sectional diagram of a manufacturing method of an electrochemical affinity sensing chip integrated with fluidic stirring according to an embodiment of the invention along line I-I′ in FIG. 2.

FIG. 6 illustrates a cyclic voltammogram using a conventional external Ag/AgCl electrode as a reference electrode in a three-electrode electrochemical sensing system.

FIG. 7 illustrates a cyclic voltammogram using a Pd-coated second ring electrode according to an embodiment of the invention as a reference electrode in a three-electrode electrochemical sensing system.

FIG. 8 illustrates a hybridization curve diagram over time of electrochemical affinity sensing chips integrated with fluidic stirring by the ACEOF stirring and the DC-biased ACEOF stirring respectively according to an embodiment of the invention.

FIG. 9 illustrates a calibration curve diagram of hybridization of electrochemical affinity sensing chips integrated with fluidic stirring by the ACEOF stirring and the DC-biased ACEOF stirring respectively according to an embodiment of the invention.

### DESCRIPTION OF EMBODIMENTS

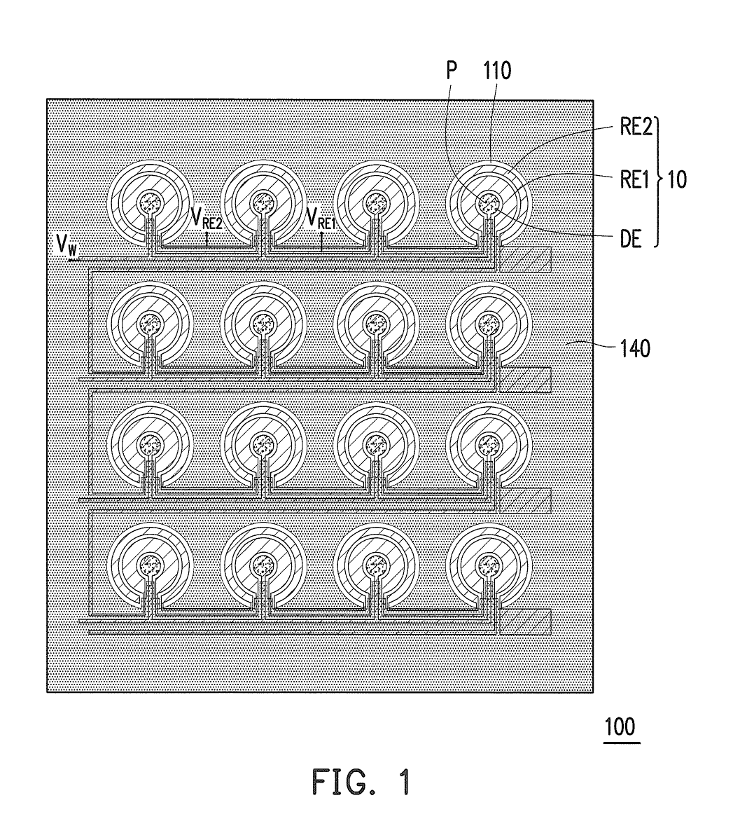

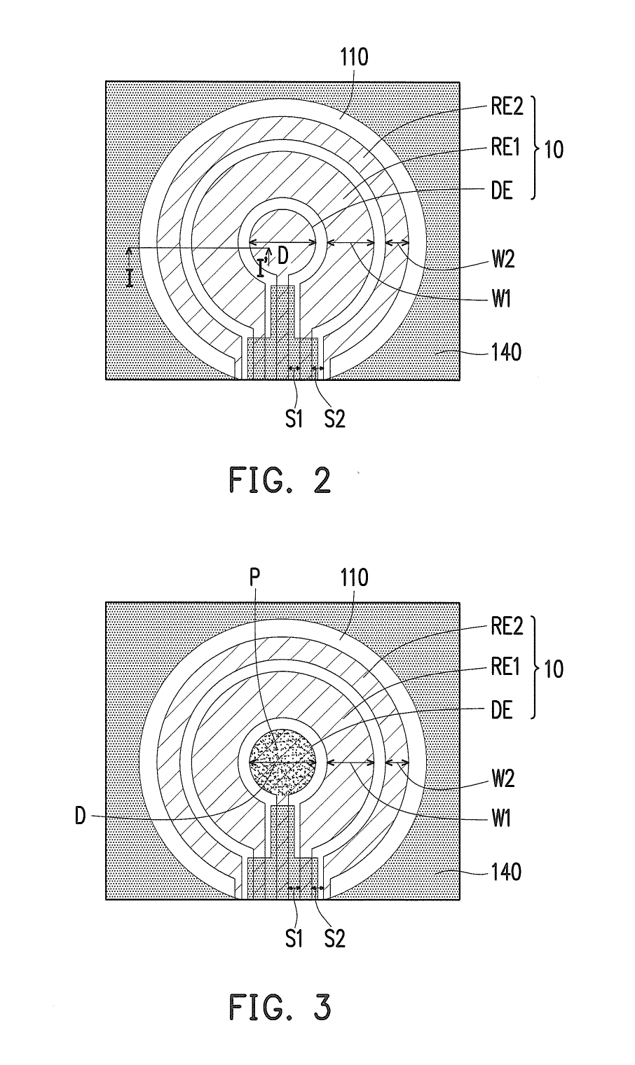

FIG. 1 illustrates a schematic diagram of an electrochemical affinity sensing chip integrated with fluidic stirring according to an embodiment of the invention. FIG. 2 illustrates a schematic diagram of a single electrochemical-sensing electrode group which is not immobilized with a probe according to an embodiment of the invention. FIG. 3 illustrates a schematic diagram of a single electrochemical-sensing electrode group which is immobilized with a probe according to an embodiment of the invention. Please refer to FIG. 1 to FIG. 3 simultaneously.

In the present embodiment, as shown in FIG. 1 to FIG. 3, an electrochemical affinity sensing chip integrated with fluidic stirring 100 includes a substrate 110 and a plurality of electrochemical-sensing electrode groups 10. The material of the substrate 110 includes, for example, glass, or a silicon layer covered with silicon dioxide or silicon nitride, but the invention is not limited thereto. The electrochemical-sensing electrode groups 10 are disposed on the substrate 110. In the present embodiment, four electrochemical-sensing electrode groups 10 are disposed in the horizontal direction and the vertical direction respectively, whereby forming an electrode array on the substrate 110, but the invention is not limited thereto. Each of the electrochemical-sensing electrode groups 10 includes a disk electrode DE, a first ring electrode RE1, and a second ring electrode RE2. Materials of the disk electrode DE, the first ring electrode RE1, and the second ring electrode RE2 are, for example, gold (Au), platinum (Pt), palladium (Pd) or other like conductive materials. The disk electrode DE is disk-shaped. A diameter of the disk electrode D is such as between 10 μm and 1000 μm, and preferably between 100 μm and 500 μm. The first ring electrode RE1 is curved and surrounds the disk electrode DE. A width of the first ring electrode W1 is such as between 10 μm and 700 μm, and preferably between 20 μm and 500 μm. The second ring electrode RE2 is curved and surrounds the first ring electrode RE1. A width of the second ring electrode W2 is such as between 5 μm and 100 μm, and preferably between 10 μm and 100 μm. It is worth mentioning that, in the present embodiment, the width of the first ring electrode W1 is such as 2 to 7 times, and preferably 5 times larger than the width of the second ring electrode W2. In addition, a first spacing S1 is located between the disk electrode DE and the first ring electrode RE1, and thus the disk electrode DE and the first ring electrode RE1 are electrically insulated from each other. The second spacing S2 is located between the first ring electrode RE1 and the second ring electrode RE2, and thus the first ring electrode RE1 and the second ring electrode RE2 are electrically insulated from each other. The substrate 110 below are exposed by the first spacing S1 and the second spacing S2. The first spacing S1 and the second spacing S2 may be the same or different from each other, wherein the first spacing S1 and the second spacing S2 are such as between 1 μm and 100 μm, but the invention is not limited thereto.

It should be noted that, the only difference between FIG. 2 and FIG. 3 is that the surface of the disk electrode DE of the electrochemical-sensing electrode groups 10 in FIG. 2 has not yet been immobilized with a probe P, however, the surface of the disk electrode DE of the electrochemical-sensing electrode groups 10 in FIG. 3 has already been immobilized with the probe P. In the present embodiment, the probe P includes DNA, RNA, antibodies, or aptamers, and the corresponding sensing object includes DNA, RNA, antigens, aptamers or drugs, but the invention is not limited thereto. Between the probe P and the object is through the affinity binding, wherein the affinity binding is such as an antigen-antibody interaction, a hybridization interaction between DNA, etc. In the present embodiment, when the electrochemical sensing is performed, the disk electrode DE is as a working electrode, which is connected to an external power supply and has a disk electrode voltage V_{W}, the first ring electrode RE1 is as a counter electrode, and the second ring electrode RE2 is as a reference electrode. In other embodiments, the electrochemical-sensing electrode groups 10 may also be designed to make the disk electrode DE as the working electrode, the first ring electrode RE1 as the reference electrode, and the second ring electrode RE2 as the counter electrode. In the present embodiment, when the electrohydrodynamic stirring is performed, the first ring electrode RE1 and the second ring electrode RE2 are connected to the external power supply and have the first ring electrode voltage V_{RE1} and the second ring electrode voltage V_{RE2} respectively. As shown in FIG. 1 to FIG. 3, an insulating layer 140 is peripherally disposed around each second ring electrodes RE2 to define a working area of the electrochemical-sensing electrode groups 10. Furthermore, connection line part of the disk electrode DE, the first ring electrode RE1, and the second ring electrode RE2 are shielded by the insulating layer 140. In other words, when the electrochemical sensing is performed, the actual working area is the double rings-single disk electrodes part.

It is worth mentioning that, in the present embodiment, the width of the first ring electrode W1 is larger than the width of the second ring electrode W2. Based on the above-mentioned asymmetric width design of the double rings-single disk electrodes, when the electrohydrodynamic stirring is performed in this case, the fluid containing the object may be allowed to flow from the second ring electrode RE2 with smaller width to the first ring electrode RE1 with larger width. Then, the fluid may flow to the disk electrode DE which is immobilized with the probe P according to inertia of fluid. Accordingly, the affinity binding may be accelerated. In addition, based on the above-mentioned asymmetric width design of the double rings-single disk electrodes, when the electrohydrodynamic stirring is performed to facilitate formation of the affinity binding between the probe P on the disk electrode DE and the object in the liquid, no voltage supply to the disk electrode DE is needed, and thus, influences of the probe P immobilized on the surface of the disk electrode DE by the electrohydrodynamic voltage may be avoided.

Materials of the disk electrode DE, the first ring electrode RE1, and the second ring electrode RE2 are not limited by the invention, as long as the materials are electrically conductive. The above-mentioned materials are, for example, metals, alloys, or metal oxides. Since gold may form a bonding with a sulphur and thus facilitate the bio molecules with sulphur groups to adsorb thereto, the materials of the disk electrode DE, the first ring electrode RE1, and the second ring electrode RE2 are preferably gold (Au).

Note that in order to allow the first ring electrode RE1 and the second ring electrode RE2 to easily have the faradaic charging ability and to prevent the first ring electrode RE1 and the second ring electrode RE2 from being contaminated in the subsequent process of immobilizing the probe P on the disk electrode DE, the surface of the first ring electrode RE1 and the second ring electrode RE2 may further be covered with a protective layer. Materials of the protective layer are different from materials of the disk electrode DE. In an embodiment of the invention, the protective layer is, for example, a palladium layer, a platinum layer, or an iridium oxide layer, etc. The first ring electrode RE1 and the second ring electrode RE2 covered with the protective layer may provide a stable electric potential during the electrochemical sensing process. Therefore, the first ring electrode RE1 and the second ring electrode RE2 covered with the protective layer can be used as a pseudo-reference electrode and a counter electrode. The operation method of the electrochemical affinity sensing chip integrated with fluidic stirring 100 according to an embodiment of the invention is illustrated in detail below with reference to the figures.

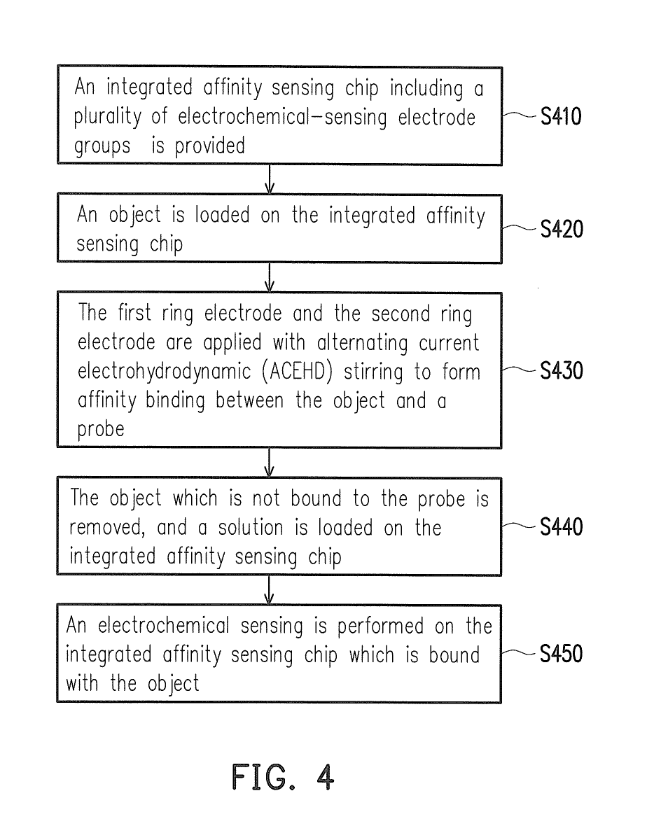

FIG. 4 illustrates a block diagram of an operation method of an electrochemical affinity sensing chip integrated with fluidic stirring according to an embodiment of the invention. Please refer to FIG. 1 to FIG. 4 simultaneously. First, in the step S410, the electrochemical affinity sensing chip integrated with fluidic stirring 100 including a plurality of electrochemical-sensing electrode groups 10 is provided, wherein the surface of the disk electrode DE in the electrochemical-sensing electrode groups 10 is immobilized with the probe P. The probe P includes DNA, RNA, antibody or aptamer, but the invention is not limited thereto. The probe P may be any bio molecules which may perform affinity reactions.

Next, in the step S420, the solution containing the object is loaded on the electrochemical affinity sensing chip integrated with fluidic stirring 100. The above-mentioned loading method is such as using a needle to add dropwise, but the way of loading the object is not limited by the invention. The object is such as DNA, RNA, antigen, aptamer, or drug, etc. As long as the object can form the affinity binding with the above-mentioned probe P, the type of the object is also not limited by the invention.

Then, in the step S430, the first ring electrode RE1 and the second ring electrode RE2 are applied with the alternating current electrohydrodynamic (ACEHD) stirring, to accelerate formation of the affinity binding between the object and the probe P. In the present embodiment, ACEHD is such as alternating current-electroosmotic flow (ACEOF), DC-biased alternating current-electroosmotic flow (DC-biased ACEOF), AC electrothermal flow, or AC electrokinetic flow, etc.

Next, in order to avoid the interference during the subsequent sensing process, in the step S440, the object which is not bound to the probe P is removed, and a neutral buffer solution containing redox pairs is loaded on the electrochemical affinity sensing chip integrated with fluidic stirring 100. The above-mentioned solution is, for example, a phosphate buffer solution containing potassium ferricyanide (K₃[Fe(CN)₆]) and potassium ferrocyanide (K₄[Fe(CN)₆]), but the invention is not limited thereto.

Finally, in the step S450, an electrochemical sensing is performed on the electrochemical affinity sensing chip integrated with fluidic stirring which is bound with the object. In the present embodiment, the electrochemical sensing is, for example, by electrochemical impedance spectroscopy (EIS) or by voltammetry, but the invention is not limited thereto.

The manufacturing method of the electrochemical affinity sensing chip integrated with fluidic stirring 100 according to an embodiment of the invention is illustrated in detail below with reference to the figures.

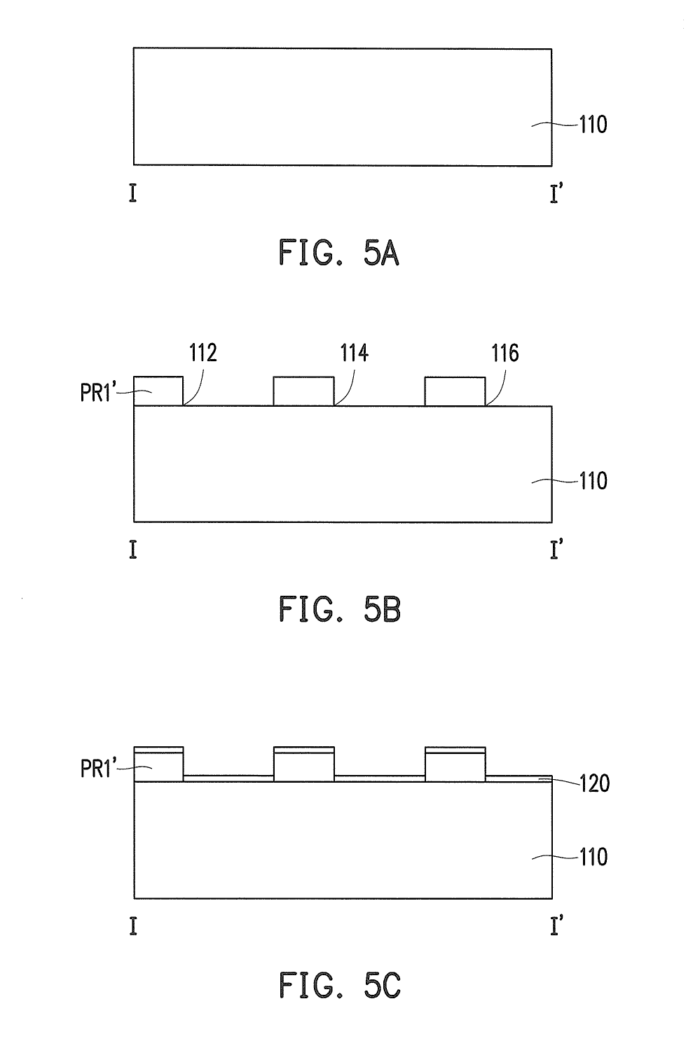

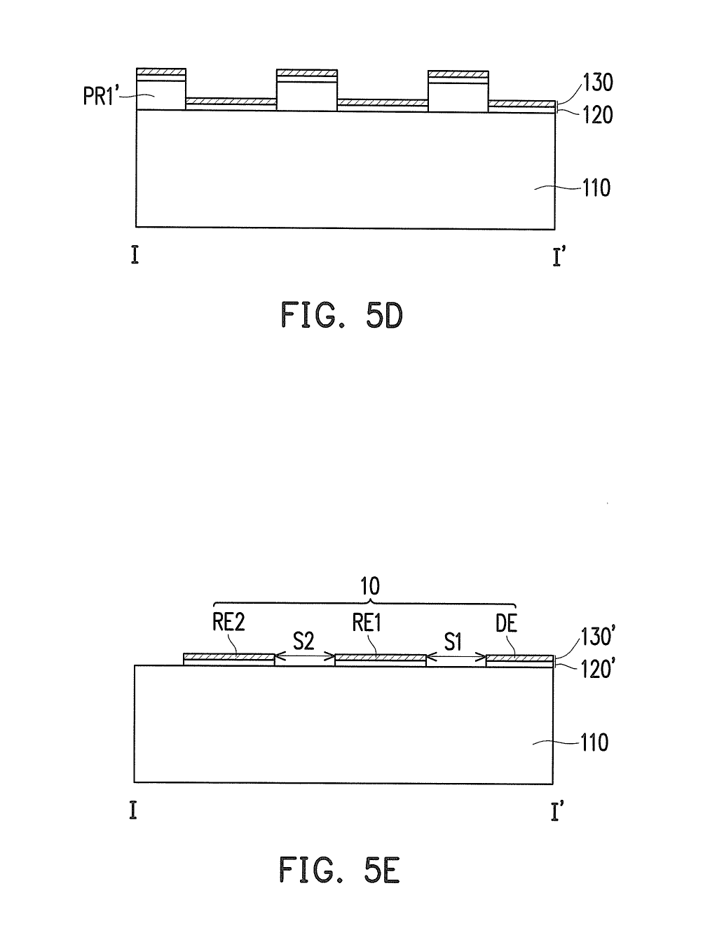

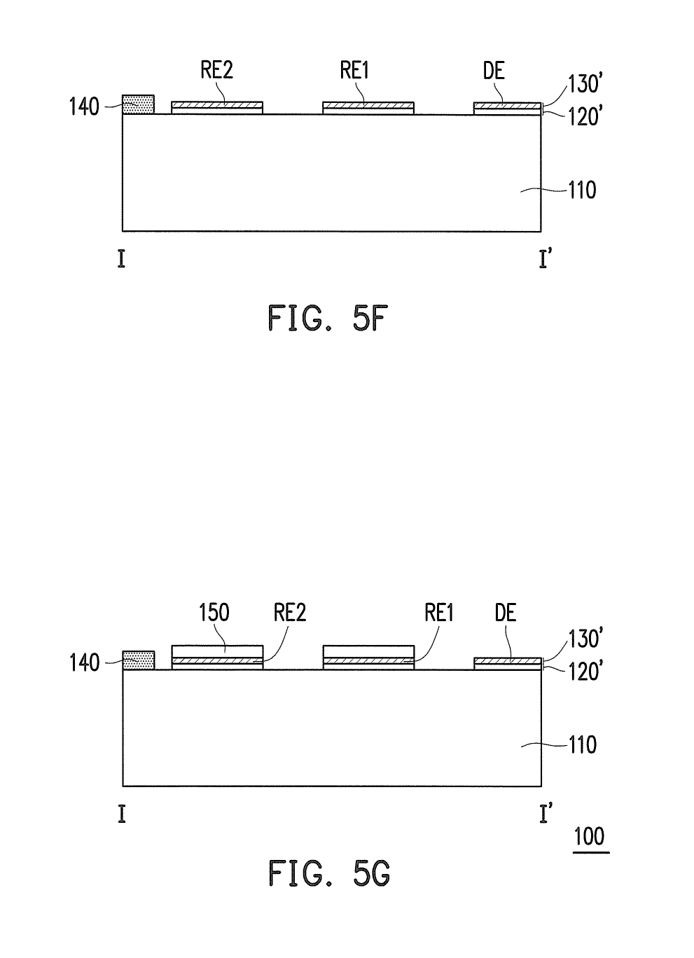

FIG. 5A to FIG. 5G illustrates a schematic cross-sectional diagram of a manufacturing method of an electrochemical affinity sensing chip integrated with fluidic stirring 100 according to an embodiment of the invention along line I-I′ in FIG. 2. First, as shown in FIG. 5A, the substrate 110 after cleaning treatment is provided. Materials of the substrate 110 are, for example, glass, or a silicon layer covered with silicon dioxide or silicon nitride, thickness of the substrate is such as in a range between 200 μm and 2 mm, but the invention is not limited thereto. The cleaning treatment is performed by, for example, sonication in a solvent. The solvent is such as acetone, isopropanol, double distilled water, etc, but the invention is not limited thereto.

Then, a photoresist layer is formed on the substrate 110 (not shown). The forming method of the photoresist layer is such as a spin coating method. The photoresist layer is such as a positive photoresist layer, but the invention is not limited thereto. In order to enhance the adhesion between the photoresist layer and the substrate 110, a soft bake treatment may be performed on the substrate 110 formed with the photoresist layer so that the solvent in the photoresist layer is removed. Next, as shown in FIG. 5B, a patterning process is performed on the photoresist layer using a mask designed with the double rings-single disk electrodes pattern according to an embodiment of the invention. Accordingly, a patterned photoresist layer PR1′ with a plurality of opening patterns 112, 114, 116 is formed, wherein the substrate 110 is exposed by the plurality of opening patterns 112, 114, 116, and the opening patterns 112, 114, 116 form the double rings-single disk electrodes pattern. Then, please refer to FIG. 5C. An adhesive layer 120 is formed on the substrate 110. The forming method of the adhesive layer 120 is such as by vapor deposition or by sputtering, etc, but the invention is not limited thereto. Next, as shown in FIG. 5D, an electrode layer 130 is formed on the substrate 110. The forming method of the electrode layer is such as by vapor deposition or by sputtering, etc, but the invention is not limited thereto. Then, as shown in FIG. 5E, the patterned photoresist layer PR1′ is removed to form a plurality of adhesive layer patterns 120′ and electrode patterns 130′. The plurality of electrode patterns 130′ includes a plurality of electrochemical-sensing electrode groups 10. To facilitate the description, only one electrochemical-sensing electrode group 10 is illustrated herein. The single electrochemical-sensing electrode group 10 includes the disk electrode DE, the first ring electrode RE1, and the second ring electrode RE2. The disk electrode DE is disk-shaped. The first ring electrode RE1 is curved and surrounds the disk electrode DE. The second ring electrode RE2 is curved and surrounds the first ring electrode RE1. A first spacing S1 is located between the disk electrode DE and the first ring electrode RE1 and thus the substrate 110 is exposed thereby. Moreover, a second spacing S2 is located between the first ring electrode RE1 and the second ring electrode RE2 and thus the substrate 110 is exposed thereby.

Next, in order to define the working area of the electrochemical-sensing electrode groups 10, as shown in FIG. 5F, the insulating layer 140 is peripherally formed around the second ring electrode RE2. The insulating layer 140 is preferably a photoresist layer, and more preferably a negative photoresist layer, but the invention is not limited thereto. In the case that the insulating layer is the photoresist layer, in order to improve the degree of cross-linking of the photoresist, a post bake treatment may be performed on the insulating layer 140 after exposure. In addition, to enhance the adhesion between the photoresist layer and the substrate 110, a hard bake treatment may further be performed after development. The method of forming the insulating layer 140 is such as the spin coating method, but the invention is not limited thereto. Finally, as shown in FIG. 5G, in the present embodiment, a protective layer 150 may further be formed on the surface of the first ring electrode RE1 and the second ring electrode RE2. Materials of the protective layer 150 are different from the materials of the disk electrode DE, wherein the protective layer 150 is preferably a palladium layer, a platinum layer or an iridium oxide layer, etc. Based on the manufacturing method as shown in FIG. 5A to FIG. 5G, the electrochemical affinity sensing chip integrated with fluidic stirring 100 according to an embodiment of the invention may be accomplished.

The invention is to be further described using following examples. However, it should be understood that these examples are only for illustrative and should not be construed as limiting the present invention.

The examples below exemplify a sensing chip which needs the three-electrode and performs the sensing by EIS, wherein the ACEOF and the DC-biased ACEOF stirring techniques are used, to illustrate that the EHD-driving electrode may be integrated into the electrochemical affinity sensing electrode groups, and the fast hybridization and the electrochemical sensing may be performed on the same chip, but the invention is not limited thereto.

### Example 1

### Manufacture of the Electrode Groups

(1) The slides are immersed in the double distilled water and sonicated for 5 minutes by 3 times. After being taken out and dried, the slides are placed into isopropanol and sonicated for 30 minutes, and then placed into the double distilled water and sonicated for 5 minutes repeating by 3 to 5 times, to remove residual isopropanol. After being taken out and dried, the slides are placed into sulfuric acid: hydrogen peroxide (3:1) solution (a piranha solution) and water-heated to 80° C. After heating, the slides are sonicated for 30 minutes, and then removed into the double distilled water for 3-5 times 5 minutes sonication, to remove the residual piranha solution. The cleaned slides are removed out and baked at 95° C. for 5 minutes, to remove the residual moisture on the slides.

(2) A positive photoresist (AZ4620, Shipley) is coated on the slides by the spin coating method. The conditions of the spin coating are as follows: the first rotation is 500 rpm for 10 seconds, and the second rotation is 3000 rpm for 40 seconds. The thickness of the formed positive photoresist is about 2 μm. The coated slides are placed on a 95° C. hot plate to soft bake for 10 minutes, and then annealed to the room temperature.

(3) The slides are exposed under UV light at a wavelength of 365 nm. The exposure dose is 135 mJ/cm², and a mask with the electrode pattern shown in FIG. 2 is used to form a positive photoresist sacrificial layer by photolithographic etching.

(4) A developing stock solution is diluted with the double distilled water at a ratio of 1:2. Then, the development is performed for about 2 minutes and the residual developing solution is removed by the double distilled water.

(5) A 20 nm titanium layer as an adhesive layer is first deposited and then a 200 nm gold layer is deposited on the chip by vapor deposition or by sputtering. The electrode after the sputtering is immersed into the acetone solution to remove the positive photoresist sacrificial layer, and a gold electrode pattern is obtained. The cleaned electrode is baked at 95° C. for 5 minutes to remove the residual moisture. Then, subsequent treatments of defining the area of the gold film electrode are performed.

(6) A negative photoresist (SU-3010) is coated on the chip by the spin coating method. The conditions of the spin coating are as follows: the first rotation is 500 rpm for 10 seconds, and the second rotation is 2500 rpm for 40 seconds. The thickness of the formed negative photoresist is about 6 μm to 8 μm. The coated chip is placed on a hot plate to perform the soft-bake treatment at 65° C. and continues for 3 minutes. After that, the coated chip is heated to 95° C. and continues for 10 minutes, and then annealed to the room temperature.

(7) An electrode is placed under UV light at a wavelength of 365 nm. The exposure dose is 320 mJ/c m². The chip after the exposure is placed on the hot plate to perform the post bake treatment.

(8) The development is performed for about 2 minutes using the developing stock solution of the negative photoresist. Then, the chip is rinsed with the clean developing stock solution of the negative photoresist and isopropanol. After that, the chip is placed on the 150° C. hot plate to perform hard bake treatment for 10 minutes.

### Example 2

### Manufacture of the Palladium Layer

The Au electrode is placed in a 1 mM palladium coating solution (containing 1 mM K₂PdCl₆ and 0.1 M sulfuric acid, pH 1.10), an electrodeposition is performed with an external Ag/AgCl reference electrode and a platinum (Pt) counter electrode, and the double-rings electrodes are connected to a multifunctional potentiostat (model number: CHI 7051B, Austin, Tex., available from CHI Instruments company). The potential stability of the electrodes when performing the electrodeposition is estimated.

The deposition parameters are as follows:

Step 1: Using linear sweep voltammetry (LSV) to set the voltage to be from +0.6V to 0V and the scan rate to be at 50 mV/s. Five scans are performed.

Step 2: The voltage is set at the half peal potential (E_{p/2}) and the deposition is performed for 900 seconds. The E_{p/2} of the present example is about 0.43V.

An open circuit potential (OCP) analysis is performed to the above-mentioned double-rings electrodes coated with the palladium layer (hereinafter referred to as Pd/Au electrodes) in a solution containing 5 mM potassium ferricyanide (K₃[Fe(CN)₆]) and potassium ferrocyanide (K₄[Fe(CN)₆]). The results show that comparing to OCP of the external Ag/AgCl electrode, OCP of the first ring Pd/Au electrode and the second ring Pd/Au electrode are about +188.1 mV and +187.5 mV, respectively. In addition, the results also show that before and after the Pd/Au electrodes being modified with a probe DNA (pDNA)/mercaptohexanol (MCH), the potential drift thereof within 30 minutes is only about 0.2 mV, and the potential drift is unaffected by the modification with pDNA/MCH. Accordingly, after being modified with pDNA/MCH, the Pd/Au electrodes may still maintain the stable potential without being affected by the modification procedures.

### Example 3

### Sensing of Geminiviridae Nucleic Acid

The nucleic acid sequence which is to use (synthesized by Bio Basic Inc.) is purified by HPLC and 105 μL double distilled water is dripped into the tube containing the DNA powder. Then, the DNA adsorbed on the wall of the tube is desorbed by centrifugation. After measuring the optical density of the DNA, tris(hydroxymethyl)aminomethane (Tris) containing 1 M NaCl (hereinafter referred to as Tris(NaCl)) (pH7.0) is mixed with the DNA to form a 100 μM DNA solution. Experimental procedures of the DNA modification and the affinity experiments are described in detail as follows.

Step 1: 15 μL of 0.1 μM to 10 μM thiolated probe DNA solution (please refer to Table 1 for the DNA sequence) (Tris(NaCl)) is dripped onto the electrode and the modification of the electrode is performed for 2 hours. Thiolated pDNA molecules are immobilized onto the surface of the gold electrode by the gold-sulphur binding. After washing the electrode surface with the double distilled water, 20 μL Tris(NaCl) is dripped on the electrode surface for 10 minutes, so that the DNA which is not bonded thereto is free from the electrode surface. Then, the electrode surface is washed with the double distilled water. The amount of the probe modified on the electrode surface is analysed by EIS and cyclic voltammetry (CV).

Step 2: 20 μL of 1 mM MCH solution (prepared in the double distilled water) is dripped onto the electrode for 1 hour. After being moistened with the double distilled water, the electrode surface is dripped with 20 μL double distilled water for 10 minutes, so that the MCH which is not bonded thereto is free from the electrode surface. Then, the electrode surface is washed with the double distilled water. Background parameter values before the hybridization reaction with the object DNA are analysed by EIS and CV.

Step 3: 20 μL object DNA of different concentrations (prepared in 1 mM Tris solution (pH 9.3)) are dripped onto the electrode surface and the hybridization reaction which is electrically controlled by the ACEOF is performed.

Step 3′: After the step 2, 20 μL object DNA of different concentrations (prepared in 1 mM Tris solution (pH 9.3)) are dripped onto the electrode surface and the hybridization reaction which is electrically controlled by the DC-biased ACEOF is performed.

TABLE 1

| | sequence |
|---|---|
| pDNA | 5′-SH-6(CH2)-CTA AAT CGA GCT CCG ACG TC |
| | The source is from Geminiviridae, 20 |
| | mer, the 5′ end thereof is modified |
| | with the thiol group and is designed |
| | to have a six-carbon-chain spacer |
| object | 5′-GAC GTC GGA GCT CGA TTT AG |
| DNA | The source is from Geminiviridae, 20 |
| | mer, fully complementary with pDNA |

Electrochemical Measurement Using the Ring Electrode Coated with Palladium as a Reference Electrode

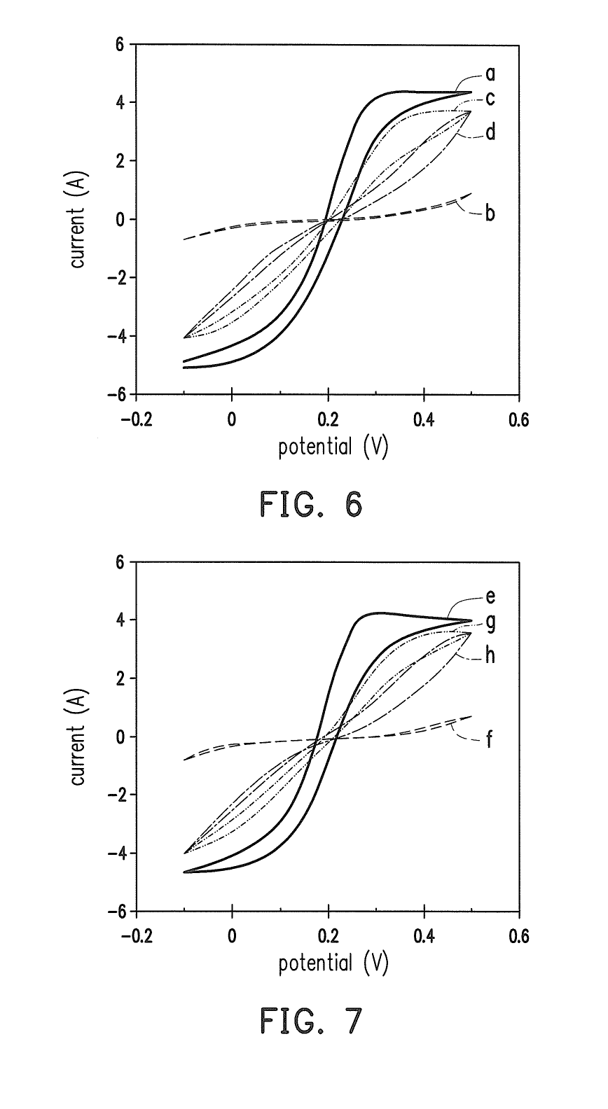

The electrochemical measurements with electroactive substances of 5 mM potassium ferricyanide and potassium ferrocyanide are performed by CV. The external Ag/AgCl electrode and the outer ring electrode coated with palladium according to an embodiment of the invention (hereinafter referred to as Pd/Au-outer ring electrode) are used as the reference electrodes, to analyze the effects on the electrochemical measurements by different reference electrodes. The results are shown in FIG. 6 and FIG. 7 respectively. FIG. 6 illustrates cyclic voltammograms using the conventional external Ag/AgCl electrode as the reference electrode in the three-electrode electrochemical sensing system, wherein the scan rate is 20 mV/s. FIG. 7 illustrates cyclic voltammograms using the Pd-coated second ring electrode according to an embodiment of the invention as the reference electrode in the three-electrode electrochemical sensing system, wherein the scan rate is 20 mV/s. The horizontal axis represents the potential (V), and the vertical axis represents the current (μA). In FIG. 6, the curve “a” represents the electrochemical measurement performed with 5 mM potassium ferricyanide and potassium ferrocyanide by using the bare disk electrode DE as the working electrode. The curve “b” represents the electrochemical measurement performed by using the disk electrode DE modified with the pDNA as the working electrode. The curve “c” represents the electrochemical measurement performed by using the disk electrode DE first modified with the pDNA and then modified with MCH as the working electrode. The curve “d” represents the electrochemical measurement performed by using the disk electrode DE first modified with pDNA/MCH and then hybridized with 1 nM object DNA as the working electrode. In FIG. 7, the curve “e” represents the electrochemical measurement performed with 5 mM potassium ferricyanide and potassium ferrocyanide by using the bare disk electrode DE as the working electrode. The curve “f” represents the electrochemical measurement performed by using the disk electrode DE modified with the pDNA as the working electrode. The curve “g” represents the electrochemical measurement performed by using the disk electrode DE first modified with the pDNA and then modified with MCH as the working electrode. The curve “h” represents the electrochemical measurement performed by using the disk electrode DE first modified with pDNA/MCH and then hybridized with 1 nM object DNA as the working electrode.

In addition, the EIS measurements are performed in the 5 mM potassium ferricyanide and potassium ferrocyanide solution, wherein the disk electrode DE is used as the working electrode, and the external Ag/AgCl electrode and the Pd/Au-outer ring electrode are used as the reference electrode, respectively. The values of electron transfer resistance (Rₑₜ) obtained by analysis of equivalent circuit simulation are compared respectively, and the Rₑₜ values are listed in Table 2 below, wherein the Rₑₜ values represent electrochemical states of the interface between the electrode/electrolyte on the disk electrode DE.

In Table 2, “bare electrode” represents the disk electrode without any modification. “pDNA” represents the disk electrode modified with the pDNA. “pDNA/MCH” represents the disk electrode modified first with the pDNA and then modified with MCH. “pDNA/MCH/object DNA” represents the disk electrode first modified with pDNA/MCH and then hybridized with the object DNA.

TABLE 2

| | Rₑₜ (kΩ) | |
|---|---|---|
| | external Ag/AgCl | Pd/Au-outer ring |
| | reference electrode | reference electrode |
| bare electrode | 6.16 ± 0.1 | 6.78 ± 0.1 |
| pDNA | 324.63 ± 1.6 | 323.83 ± 0.5 |
| pDNA/MCH | 214.07 ± 0.8 | 213.63 ± 0.4 |
| pDNA/MCH/object DNA | 333.67 ± 0.7 | 333.77 ± 0.3 |

First, the CV analysis results of which the external Ag/AgCl electrode and the Pd/Au-outer ring electrode are used as the reference electrode are compared. Please refer to FIG. 6, FIG. 7, and Table 2 simultaneously. No matter which reference electrode the CV measurement used, the current response exhibited a similar change after pDNA/MCH modification and object DNA hybridization. There is no significant difference between the peak current values (curve “e” to “h”) obtained when the Pd/Au-outer ring electrode is used as the reference electrode and the peak current values (curve “a” to “d”) obtained when the Ag/AgCl electrode is used as the reference electrode; in addition, the Rₑₜ values thereof obtained by the EIS measurement are almost the same. Accordingly, in the electrochemical sensing system of the affinity sensing chip 100 according to an embodiment of the invention, the Pd/Au-outer ring electrode may be used as a pseudo-reference electrode.

It should be noted that, in the above-mentioned step 2, the modification of MCH is for blocking the bare area of the electrode surface which is not modified with the pDNA. The blocking phenomenon may be verified from the CV analysis results (as shown in FIG. 6, FIG. 7, and Table 2). After the pDNA/MCH composite layer is formed on the electrode surface, the peak current thereof is larger than the peak current of the electrode which is only modified with the pDNA. In addition, as shown in Table 2, the Rₑₜ value of the pDNA/MCH electrode is less than the Rₑₜ value of the electrode which is only modified with the pDNA. Accordingly, after the modification of MCH, the pDNA which is not covalently bonded to the electrode surface through Au—S bonding may be desorbed from the surface, so as to further decrease the DNA molecules which are non-specifically bound (such as through Au—N bonding) to the electrode surface.

Moreover, whether the hybridization reaction of the object DNA is performed may be further determined from the change of the Rₑₜ values. As shown in Table 2, the Rₑₜ value of the pDNA/MCH/object DNA electrode is larger than the Rₑₜ value of the pDNA/MCH electrode. The reason thereof is that after the pDNA hybridizing with the object DNA to form double-stranded DNA, a denser molecular layer is formed on the electrode surface, which further inhibits the redox peak current signals of potassium ferricyanide and potassium ferrocyanide. Accordingly, the peak current value of the pDNA/MCH/object DNA electrode is less than the peak current value of the pDNA/MCH electrode.

Biosensor Characteristics after the ACEOF Stirring and the DC-Biased ACEOF

During the hybridization reaction, the ACEOF stirring with the control conditions of 3.0Vₚₚ amplitude and 380 Hz frequency, and the ACEOF stirring with additionally applied +0.7 V DC (that is, the DC-biased ACEOF) is performed to the fluid. Specifically, about 20 μL of 1 mM Tris solution (pH 9.3) containing 1 nM object DNA is dripped onto the electrode chip which is modified with the pDNA/MCH composite layer. Next, after each drive for 30 seconds by ACEOF or DC-biased ACEOF, the amounts of change of the Rₑₜ values over time of the disk electrode DE after the hybridization are measured by EIS, wherein the Pd/Au-first ring electrode is used as the counter electrode, and the Pd/Au-second ring electrode is used as the reference electrode.

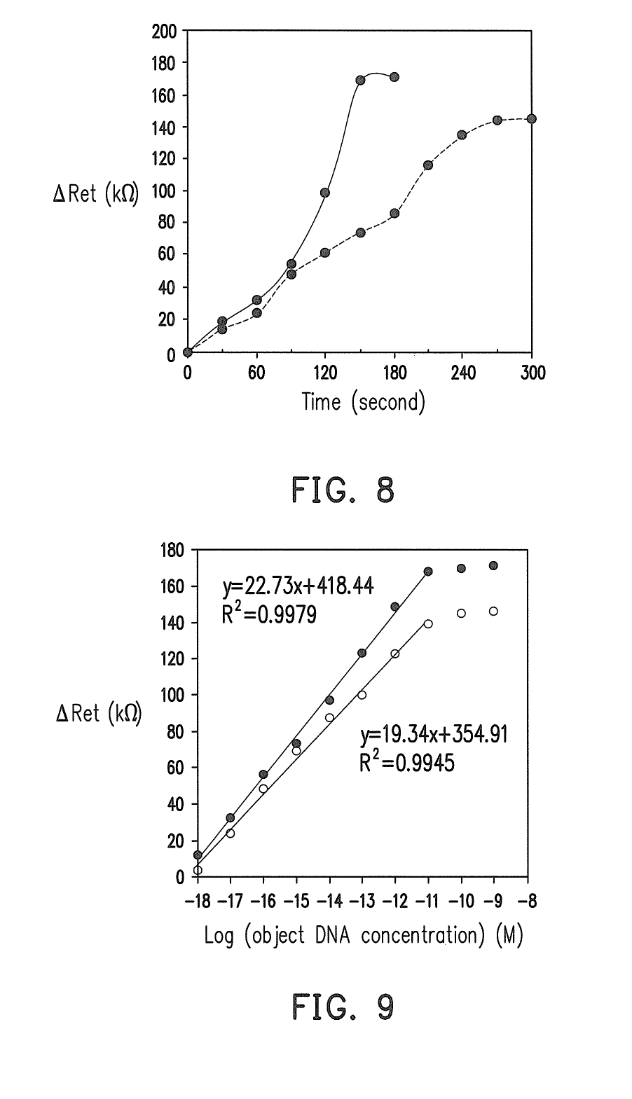

FIG. 8 illustrates a hybridization curve diagram over time of the electrochemical affinity sensing chips integrated with fluidic stirring by the ACEOF stirring and the DC-Biased ACEOF stirring respectively according to an embodiment of the invention. The horizontal axis represents the time (second), and the vertical axis represents the change of the Rₑₜ value (ΔRₑₜ=Rₑₜ value of the pDNA/MCH/object DNA electrode−Rₑₜ value of the pDNA/MCH electrode)(kΩ). A dashed line represents the ACEOF stirring and a solid line represents the DC-biased ACEOF stirring. First, refer to the dashed line in FIG. 8. In the bio-sensing performed under the ACEOF stirring, the ΔRₑₜ values thereof continue to rise with the ACEOF stirring every 30 seconds and become steady until 270 seconds, at which the ΔRₑₜ value is about 145.17±1.55 kΩ. After 300 minutes, the ΔRₑₜ value may reach 146.17±0.61 kΩ and has become saturated. The calculated reaction time which is required to reach 90% of saturation under the ACEOF stirring is about 256 seconds. Next, refer to the solid line in FIG. 8. In the DC-biased bio-sensing performed under the ACEOF stifling, the ΔRₑₜ values thereof continue to rise every 30 seconds and become steady until 150 seconds, at which the ΔRₑₜ value is about 168.6±3.89 kΩ. After 180 minutes, the ΔRₑₜ value may reach 171.8±4.25 kΩ, and has become saturated. The calculated reaction time which is required to reach 90% of saturation under the DC-biased ACEOF stirring is about 148 seconds. According to the above results, as compared to the ACEOF stirring, the object DNA which is dispersed around in the liquid may be more effectively brought to the electrode surface by the DC-biased ACEOF stirring to perform the hybridization reaction with the pDNA, thereby the shorter saturated hybridization time and the preferred hybridization density are obtained. In addition, either by applying a higher AC potential or by applying an appropriate DC bias, a faster liquid flow rate may be produced, thereby facilitating the hybridization reaction to be occurred.

FIG. 9 illustrates a calibration curve diagram of hybridization of electrochemical affinity sensing chips integrated with fluidic stirring by the ACEOF stiffing and the DC-Biased ACEOF stiffing respectively according to an embodiment of the invention. The horizontal axis represents a logarithmic value of the object DNA concentration (M), and the vertical axis represents the change of the Rₑₜ value (ΔRₑₜ=Rₑₜ value of the pDNA/MCH/object DNA electrode−Rₑₜ value of the pDNA/MCH electrode)(kΩ). The saturated hybridization time of 270 seconds and 150 seconds are used for ACEOF and DC-Biased ACEOF, respectively, to analyze the calibration curves thereof at different object DNA concentrations. The results thereof are shown in FIG. 9. A linear range of the hybridization obtained by the DC-Biased ACEOF stirring (see solid circles in FIG. 9) is form 1 aM to 10 pM, and a regression equation thereof is Δ Rₑₜ(kΩ)=22.73 Log [object DNA](M)+418.44, wherein a R² value is 0.9979. A linear range of the hybridization obtained by the ACEOF stirring (see hollow circles in FIG. 9) is form 1 aM to 10 pM, and a regression equation thereof is Δ Rₑₜ(kΩ)=19.34 Log [object DNA](M)+354.91, wherein a R² value is 0.9945. According to the above results, a sensitivity of the hybridization by the DC-Biased ACEOF stirring is larger than a sensitivity of the hybridization by the ACEOF stirring, wherein the phenomenon may be due to the fact that the faster liquid flow rate and a larger flow field may be produced by the DC-Biased ACEOF as compared to the ACEOF.

It should be noted that, based on the design of the double rings-single disk electrode and the method of the DC-Biased ACEOF stirring, the detection limit (0.4 aM) of the electrochemical affinity sensing chip integrated with fluidic stirring 100 according to an embodiment of the invention is far lower than the detection limit (10 aM) of a sensing chip designed as single ring-single disk electrode. Accordingly, with the double rings-single disk electrochemical-sensing electrode groups 10 in the electrochemical affinity sensing chip integrated with fluidic stirring 100 according to an embodiment of the invention, the DNA hybridization reaction may be more effectively performed and background noises of the detection may be reduced.

According to the above, in the invention, the electrochemical affinity sensing chip integrated with fluidic stirring and the operation method thereof are provided. By the design of the double rings-single disk electrode in the electrochemical affinity sensing chip integrated with fluidic stirring of the invention, the ACEHD technique and the electrochemical sensing technique are integrated into the same electrode group and the same chip. Thereby, the affinity binding efficiency may be increased dramatically, the detection limit may be reduced, and the sensing time may be shortened. Further, with the electrochemical affinity sensing chip integrated with fluidic stirring of the invention, the electrochemical sensing may be directly performed in the same double rings-single disk electrode group without the assistance of the external electrode, whereby the miniaturization of the biosensing chip may be realized.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. An electrochemical affinity sensing chip integrated with fluidic stirring, suitable for sensing an object, comprising:
a substrate; and
a plurality of electrochemical-sensing electrode groups, disposed on the substrate and electrochemically sensing the object, wherein each of the electrochemical-sensing electrode groups comprises:
a disk electrode, which is disk-shaped;
a first ring electrode, which is curved and surrounding the disk electrode; and
a second ring electrode, which is curved and surrounding the first ring electrode,
wherein a surface of the disk electrode is immobilized with a probe, and the first ring electrode and the second ring electrode produce an alternating current electrohydrodynamic (ACEHD) stirring.

2. The electrochemical affinity sensing chip integrated with fluidic stirring as claimed in claim 1, wherein the alternating current electrohydrodynamic stirring comprises alternating current-electroosmotic flow (ACEOF), DC-biased alternating current-electroosmotic flow (DC-biased ACEOF), AC electrothermal flow, or AC electrokinetic flow, and the electrochemical sensing comprises electrochemical impedance spectroscopy (EIS) or voltammetry.

3. The electrochemical affinity sensing chip integrated with fluidic stirring as claimed in claim 1, wherein the probe comprises DNA, RNA, an antibody, or an aptamer, the object comprises DNA, RNA, an antigen, an aptamer or drug, and the probe and the object are affinity binding therebetween.

4. The electrochemical affinity sensing chip integrated with fluidic stirring as claimed in claim 1, wherein a first spacing is located between the disk electrode and the first ring electrode, a second spacing is located between the first ring electrode and the second ring electrode, and the first spacing and the second spacing are between 1 μm and 100 μm.

5. The electrochemical affinity sensing chip integrated with fluidic stirring as claimed in claim 1, wherein a width of the first ring electrode is between 10 μm and 700 μm, a width of the second ring electrode is between 5 μm and 100 μm, and a diameter of the disk electrode is between 10 μm and 1000 μm.

6. The electrochemical affinity sensing chip integrated with fluidic stirring as claimed in claim 1, wherein a width of the first ring electrode is larger than a width of the second ring electrode, and the width of the first ring electrode is 2 to 7 times larger than the width of the second ring electrode.

7. The electrochemical affinity sensing chip integrated with fluidic stirring as claimed in claim 1, wherein materials of the disk electrode, the first ring electrode, and the second ring electrode comprise gold (Au), platinum (Pt), or palladium (Pd).

8. The electrochemical affinity sensing chip integrated with fluidic stirring as claimed in claim 1, wherein a surface of the first ring electrode and a surface of the second ring electrode are covered with a protective layer, and material of the protective layer are different from material of the disk electrode.

9. The electrochemical affinity sensing chip integrated with fluidic stirring as claimed in claim 8, wherein the protective layer comprises a palladium layer, a platinum layer or an iridium oxide layer.

10. An operation method of an electrochemical affinity sensing chip integrated with fluidic stirring, suitable for sensing an object, comprising:
providing an electrochemical affinity sensing chip integrated with fluidic stirring which comprises a plurality of electrochemical-sensing electrode groups, wherein each of the electrochemical-sensing electrode groups comprises:
a disk electrode, which is disk-shaped and a surface thereof is immobilized with a probe;
a first ring electrode, which is curved and surrounding the disk electrode; and
a second ring electrode, which is curved and surrounding the first ring electrode;
loading the object on the electrochemical affinity sensing chip integrated with fluidic stirring;
applying a voltage to the first ring electrode and the second ring electrode to produce an alternating current electrohydrodynamic (ACEHD) stirring and to form a affinity binding between the object and the probe;
removing the object which is not bound to the probe and loading a solution on the electrochemical affinity sensing chip integrated with fluidic stirring; and
performing an electrochemical sensing on the electrochemical affinity sensing chip integrated with fluidic stirring which is bound with the object.

11. The operation method of electrochemical affinity sensing chip integrated with fluidic stirring as claimed in claim 10, wherein the alternating current electrohydrodynamic stirring comprises alternating current-electroosmotic flow (ACEOF), DC-biased alternating current-electroosmotic flow (DC-biased ACEOF), AC electrothermal flow, or AC electrokinetic flow, and the electrochemical sensing comprises electrochemical impedance spectroscopy (EIS) or voltammetry.

12. The operation method of electrochemical affinity sensing chip integrated with fluidic stirring as claimed in claim 10, wherein the object is moved from the second ring electrode to the first ring electrode by the alternating current electrohydrodynamic stirring, and the object is moved to the disk electrode which is immobilized with the probe according to inertia of fluid.

13. The operation method of electrochemical affinity sensing chip integrated with fluidic stirring as claimed in claim 10, wherein in the electrochemical sensing, the disk electrode serves as a working electrode, and one of the first ring electrode and the second ring electrode serves as a counter electrode and another serves as a reference electrode.

14. The operation method of electrochemical affinity sensing chip integrated with fluidic stirring as claimed in claim 10, wherein a surface of the first ring electrode and a surface of the second ring electrode are covered with a protective layer to form a faradaic charging phenomenon at the first ring electrode and the second ring electrode, wherein materials of the protective layer and materials of the disk electrode are different.

15. The operation method of electrochemical affinity sensing chip integrated with fluidic stirring as claimed in claim 14, wherein the protective layer comprises a palladium layer, a platinum layer or an iridium oxide layer.

16. The operation method of electrochemical affinity sensing chip integrated with fluidic stirring as claimed in claim 10, wherein a width of the first ring electrode is larger than a width of the second ring electrode, and the width of the first ring electrode is 2 to 7 times larger than the width of the second ring electrode.
